(19) United States
(12) Patent Application Publication
(10) Pub. No.: US 2024/0343940 A1
(43) Pub. Date: Oct. 17, 2024

(54) COATING COMPOSITIONS BASED ON UNSATURATED POLYESTER AND PHENOLIC RESIN

(71) Applicant: Eastman Chemical Company, Kingsport, TN (US)

(72) Inventors: Katelyn Rose Houston, Johnson City, TN (US); Samuel Jean Puaud, Lille (FR); Hongkun He, Kingsport, TN (US); Goliath Beniah, Johnson City, TN (US); Cameron Lee Brown, Kingsport, TN (US)

(73) Assignee: Eastman Chemical Company, Kingsport, TN (US)

(21) Appl. No.: 18/577,762

(22) PCT Filed: Jul. 13, 2022
(86) PCT No.: PCT/US2022/036914

§ 371 Date: Jan. 9, 2024

Related U.S. Application Data
(60) Provisional application No. 63/203,254, filed on Jul. 14, 2021.

(51) Int. Cl. C09D 167/06; C08G 63/553

(52) U.S. Cl. CPC C09D 167/06; C08G 63/553

(57) ABSTRACT

Unsaturated polyester compositions comprising cycloaliphatic diols such as 2,2,4,4-tetramethyl-1,3-cyclobutanediol (TMCD) that are curable with an isocyanate crosslinker, an amino crosslinker, or a combination thereof are provided herein. The unsaturated polyester compositions provide a good balance of desirable coating properties such as solvent resistance and wedge bend resistance in metal packaging applications.

### FIELD OF THE INVENTION

This invention relates to improved unsaturated polyester compositions that are curable with resole phenolic resins. More particularly, this invention relates to unsaturated polyester compositions comprising 2,2,4,4-tetramethyl-1,3-cyclobutanediol (TMCD). Coating compositions prepared from such unsaturated polyesters are capable of providing a good balance of desirable coating properties such as solvent resistance and wedge bend resistance for metal packaging applications.

### BACKGROUND OF THE INVENTION

Metal containers are commonly used for food and beverage packaging. The containers are typically made of steel or aluminum. A prolonged contact between the metal and the filled product can lead to corrosion of the container. To prevent direct contact between filled product and metal, a coating is typically applied to the interior of the food and beverage cans. In order to be effective, such a coating must have certain properties that are needed for protecting the packaged products, and the integrity of the metal container, such as adhesion, corrosion resistance, chemical resistance, flexibility, stain resistance, and hydrolytic stability. Moreover, the coating must be able to withstand processing conditions during can fabrication and food sterilization. Coatings based on a combination of epoxy and phenolic resins are known to be able to provide a good balance of the required properties and are most widely used. Some industry sectors are moving away from food contact polymers made with bisphenol A (BPA), a basic building block of epoxy resins. Thus, there exists a need for non-BPA containing coatings for use in interior can coatings.

Polyesters have been of particular interest to the coating industry to be used as replacements for epoxy resins because of their comparable properties such as flexibility and adhesion. It is known by one skilled in the art that crosslinking between common polyester polyol and phenolic resin is too poor to provide adequate properties for use in interior can coatings. Specifically, conventional polyesters having hydroxyl functionalities are not reactive enough with phenolic resins under curing conditions to provide adequate cross-linking density, resulting a coating that lacks good solvent resistance.

U.S. Pat. No. 9,650,539 discloses a thermosetting composition having (I) an unsaturated curable polyester comprising an α,β-unsaturated polycarboxylic acid compound having at least one unsaturation in a position that is α,β relative to a carbonyl group and (II) a phenolic resin having at least one methylol group. Coatings based on such thermosetting compositions are found to exhibit excellent solvent resistance resulting from improved crosslinking between the unsaturated polyester and the phenolic resin. The prior art, however, does not disclose the wedge bend resistance, which is often a shortcoming of the thermosetting coating. Such coatings tend to be less flexible and can have detrimental effects on the bending ability during processing. Thus, there remains a need for a curable coating composition for metal packaging that is capable of providing desirable wedge bend resistance as well as solvent resistance.

### SUMMARY OF THE INVENTION

There is now provided unsaturated polyester compositions comprising cycloaliphatic diols such as 2,2,4,4-tetramethyl-1,3-cyclobutanediol (TMCD), that are curable with an isocyanate crosslinker, an amino crosslinker, or a combination thereof. The unsaturated polyester compositions provide a good balance of desirable coating properties such as solvent resistance and wedge bend resistance in metal packaging applications.

In one embodiment, the invention is a coating composition for metal packaging, comprising:
a. an unsaturated polyester, which is the reaction product of the monomers comprising:
   i. 2,2,4,4-tetramethyl-1,3-cyclobutanediol (TMCD) in an amount of 30 to 60 mole %, based on the total moles of i-iii,
   ii. a diol other than TMCD in an amount of 40 to 70 mole %, based on the total moles of i-iii,
   iii. a triol in an amount of 0 to 8 mole %, based on the total moles of i-iii,
   iv. an α,β-unsaturated diacid or anhydride in an amount of 3 to 20 mole %, based on the total moles of iv-vi,
   v. an aromatic diacid in an amount of 55 to 97 mole %, based on the total moles of iv-vi, and
   vi. an aliphatic diacid in an amount of 0 to 25 mole %, based on the total moles of iv-vi, and
b. a resole phenolic resin crosslinker having at least one methylol group,
   wherein said unsaturated polyester has a glass transition temperature (Tg) of 40 to 110° C., acid number of 0 to 10 mgKOH/g, hydroxyl number of 8 to 30 mgKOH/g, number average molecular weight of 5,000 to 15,000 g/mole, and weight average molecular weight of 20,000 to 150,000 g/mole; and
      wherein said coating has a solvent resistance of greater than 50 MEK double rubs as measured by ASTM D7835 and a wedge bend resistance (% pass) of 50-100 as measured by ASTM D328.

In another embodiment, the invention is a coating composition for use in metal packaging, comprising:
a. an unsaturated polyester in an amount of 70-80 weight % based on the total weight of (a), (b), and (c), which is the reaction product of the monomers comprising:
   i. 2,2,4,4-tetramethyl-1,3-cyclobutanediol in an amount of 35 to 55 mole %, based on the total moles of i-iv,
   ii. 1,4-cyclohexanedimethanol in an amount of 25 to 45 mole %, based on the total moles of i-iv,
   iii. 1,6-hexanediol or 2-methyl-1,3-propanediol or a mixture thereof in an amount of 5 to 30 mole %, based on the total moles of i-iv,
   iv. trimethylolpropane in an amount of 0 to 5 mole %, based on the total moles of i-iv,
   v. isophthalic acid in an amount of 55-85 mole %, based on the total moles of v-vii,
   vi. terephthalic acid in an amount of 5-40 mole %, based on the total moles of v-vii, and
   vii. sebacic acid or adipic acid or a mixture thereof in an amount of 0-20 mole %, based on the total moles of v-vii,
b. a resole phenolic resin in an amount of 12-27 weight % based on the total weight of (a), (b), and (c), and
c. isophorone diisocyanate in an amount of 3-8 weight % based on the total weight of (a), (b), and (c),
   wherein said unsaturated polyester has a glass transition temperature (Tg) of 40 to 100° C.; an acid number of 0 to 10 mgKOH/g; a hydroxyl number of 8 to 23 mgKOH/g; a number average molecular weight of 5,000 to 13,000 g/mole; and a weight average molecular weight of 25,000 to 130,000 g/mole; and wherein said coating has a solvent resistance of greater than 60 MEK double rubs as measured by ASTM D7835; and a wedge bend resistance (% pass) of 60-100 as measured by the method of ASTM D3281.

### DETAILED DESCRIPTION OF THE INVENTION

### Definitions

In this specification and in the claims that follow, reference will be made to a number of terms, which shall be defined to have the following meanings.

“Alkyl” means an aliphatic hydrocarbon. The alkyl can specify the number of carbon atoms, for example (C1-5)alkyl. Unless otherwise specified, the alkyl group can be unbranched or branched. In one embodiment, the alkyl group is branched. In one embodiment, the alkyl group is unbranched. Non-limiting examples of alkanes include methane, ethane, propane, isopropyl (i.e., branched propyl), butyl, and the like.

“Alcohol” means a chemical containing one or more hydroxyl groups.

“Aldehyde” means a chemical containing one or more-C(O) H groups.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

“Chosen from” as used herein can be used with “or” or “and.” For example, Y is chosen from A, B, and C means Y can be individually A, B, or C. Alternatively, Y is chosen from A, B, or C means Y can be individually A, B, or C, or a combination of A and B, A and C, B and C, or A, B, and C.

The present inventors have unexpectedly discovered that coating compositions based on certain unsaturated TMCD polyester compositions are capable of providing good solvent resistance and bending ability for metal packaging applications.

In one embodiment of the invention, there is provided a coating composition for use in metal packaging, comprising:
a. an unsaturated polyester, which is the reaction product of the monomers comprising:
   i. 2,2,4,4-tetramethyl-1,3-cyclobutanediol (TMCD) in an amount of 30 to 60 mole %, based on the total moles of i-iii,
   ii. a diol other than TMCD in an amount of 40 to 70 mole %, based on the total moles of i-iii,
   iii. a triol in an amount of 0 to 8 mole %, based on the total moles of i-iii,
   iv. an α,β-unsaturated diacid or anhydride in an amount of 3 to 20 mole %, based on the total moles of iv-vi,
   v. an aromatic diacid in an amount of 55 to 97 mole %, based on the total moles of iv-vi, and
   vi. an aliphatic diacid in an amount of 0 to 25 mole %, based on the total moles of iv-vi, and
b. a resole phenolic resin crosslinker having at least one methylol group,
   wherein said unsaturated polyester has a glass transition temperature (Tg) of 40 to 110° C., acid number of 0 to 10 mgKOH/g, hydroxyl number of 8 to 30 mgKOH/g, number average molecular weight of 5,000 to 25,000 g/mole, and weight average molecular weight of 20,000 to 150,000 g/mole; and
wherein said coating has a solvent resistance of greater than 50 MEK double rubs as measured by ASTM D7835 and a wedge bend resistance (% pass) of 50-100 as measured by ASTM D3281.

In some embodiments of the invention, said 2,2,4,4-tetramethyl-1,3-cyclobutanediol (TMCD) (i) is in an amount of 35-55 mole %, said diol other than TMCD (ii) in an amount of 40 to 65 mole %, said triol (iii) in an amount of 0 to 5 mole %, said α,β-unsaturated diacid or anhydride (iv) in an amount of 5 to 18 mole, said aromatic diacid (v) in an amount of 62 to 95 mole %, and said aliphatic diacid (vi) in an amount of 0 to 20 mole %.

In further embodiments, said 2,2,4,4-tetramethyl-1,3-cyclobutanediol (TMCD) (i) is in an amount of 40-50 mole %, said diol other than TMCD (ii) in an amount of 47 to 60 mole %, said triol (iii) in an amount of 0 to 3 mole %, said α,β-unsaturated diacid or anhydride (iv) in an amount of 7 to 15 mole, said aromatic diacid (v) in an amount of 67 to 93 mole %, and said aliphatic diacid (vi) in an amount of 0 to 18 mole %.

In other aspects, said 2,2,4,4-tetramethyl-1,3-cyclobutanediol (TMCD) is in an amount of 30-60, 32-58, 35-55, 37-53, 40-50, or 42-48 mole %, based on the total moles of i-iii.

In further aspects, said diol other than TMCD is in an amount of 40-70, 40-65, 42-63, 45-61, or 47-60 mole %, based on the total moles of i-iii.

In other aspects, said triol is in an amount of 0-8, 0-7, 0-6, 0-5, 0-4, 0-3, 1-8, 1-7, 1-6, 1-5, 1-4, 1-3, 1-2, 2-8, 2-7, 2-6, 2-5, 2-4, 2-3, 3-8, 3-7, 3-6, 3-5, 3-4, 4-8, 4-7, 4-6, 4-5, 5-8, 5-7, 5-6, 6-8, 6-7, or 7-8 mole %, based on the total moles of i-iii.

In other aspects, said α,β-unsaturated diacid or anhydride is in an amount of 3-20, 4-19, 5-18, 6-17, or 7-15 mole %, based on the total moles of iv-vi.

In other aspects, said aromatic diacid is in an amount of 55-97, 60-96, 62-95, 65-94, or 67-93 mole %, based on the total moles of iv-vi,

In other aspects, said aliphatic diacid is in an amount of 0-25, 0-20, 0-18, 0-15, 0-10, 0-5, 5-25, 5-20, 5-15, 5-10, 10-25, 10-20, 10-15, 15-25, 15-20, or 20-25 mole %, based on the total moles of iv-vi.

Examples of the diol other than TMCD (ii) include 1,4-cyclohexane-dimethanol, 1,3-cyclohexanedimethanol, 1,2-cyclohexanedimethanol, 1,6-hexanediol, 1,4-butanediol, 2-methyl-1,3-propanediol, neopentyl glycol, hydroxypivalyl hydroxypivalate, 2-butyl-2-ethyl-1,3-propanediol, and mixtures thereof. In some embodiments, said diol (ii) is selected from 1,4-cyclohexanedimethanol, 1,3-cyclohexanedimethanol, 1,6-hexanediol, 1,4-butanediol, 2-methyl-1,3-propanediol, neopentyl glycol, and mixtures thereof.

Examples of the triol include 1,1,1-trimethylolpropane, 1,1,1-trimethylolethane, glycerol, and mixtures thereof. Desirably, the triol is 1,1,1-trimethylolpropane.

Examples of α,β-unsaturated diacid or anhydride (iv) include maleic acid or its anhydride, crotonic acid or its anhydride, itaconic acid or its anhydride, citraconic acid or its anhydride, mesaconic acid, phenylmaleic acid or its anhydride, t-butyl maleic acid or its anhydride, and mixtures thereof. Desirably, said α,β-unsaturated diacid or anhydride (iv) is one or more selected from the group consisting of maleic anhydride, maleic acid, fumaric acid, itaconic anhydride, and itaconic acid. It should be noted that the aforementioned diacids include their monoester and diesters such as, for example, dimethyl maleate and dimethyl fumarate.

In a model compound study, the present inventors have discovered that diethyl fumarate having a trans structure is significantly more reactive with o-hydroxymethylphenol than diethyl maleate having a cis structure. Thus, said α,β-unsaturated diacid or anhydride (iv) is desirably fumaric acid. Further, the model compound study also shows that itaconate is more reactive than maleate and fumarate. Thus, said α,β-unsaturated diacid or anhydride (iv) is desirably itaconic acid or itaconic anhydride.

Examples of said aromatic diacid (v) include isophthalic acid and its esters, such as dimethyl isophthalate, and terephthalic acid and its esters such as dimethyl terephthalate.

Said aliphatic diacid (vi) includes C4-C12 diacids and their esters, such as succinic acid, adipic acid, sebacic acid, dodecanedioic acid, 1,4-cyclohexane dicarboxylic acid, 1,3-cyclohexane dicarboxylic acid, 1,2-cyclohexane dicarboxylic acid, and their methyl esters; and (hydrogenated) dimer acid (C₃₆). Desirably, when longer chain diacids (>C₁₀) are used, they are at a smaller ratio such as 1-5, 1-4, 1-3, or 1-2 mole %. In some embodiments, said aliphatic diacid is one or more selected from succinic acid, adipic acid, sebacic acid, 1,4-cyclohexane dicarboxylic acid, and 1,3-cyclohexane dicarboxylic acid. Desirably, said aliphatic diacid is sebacic acid, adipic acid, or a mixture thereof.

Said unsaturated polyester has a glass transition temperature (Tg) of 40-110° C., 40-100° C., 40-90° C., 40-80° C., 45-100° C., 50-100° C., 55-100° C., 60-100° C., 65-100° C., 45-90° C., 50-90° C., 55-90° C., 60-90° C., 65-90° C., 50-80° C., 55-80° C., or 60-80° C.

Said unsaturated polyester is synthesized in the presence of a catalyst. Examples of suitable catalysts include those based on titanium, tin, gallium, zinc, antimony, cobalt, manganese, germanium, alkali metals, particularly lithium and sodium, alkaline earth compounds, aluminum compounds, combinations of aluminum compounds with lithium hydroxide or sodium hydroxide, and mixtures of. In one embodiment, the catalyst is based on titanium or tin.

In one class of this embodiment, the catalyst is present from 1 to 500 ppm. In one subclass of this class, the catalyst is a tin catalyst. In one subclass of this class, the catalyst is a titanium catalyst.

In one class of this embodiment, the catalyst is present from 1 to 300 ppm. In one subclass of this class, the catalyst is a tin catalyst. In one subclass of this class, the catalyst is a titanium catalyst.

In one class of this embodiment, the catalyst is present from 5 to 125 ppm. In one subclass of this class, the catalyst is chosen from a tin catalyst or a titanium catalyst. In one subclass of this class, the catalyst is a tin catalyst. In one subclass of this class, the catalyst is a titanium catalyst.

In one class of this embodiment, the catalyst is present from 10 to 100 ppm. In one subclass of this class, the catalyst is chosen from a tin catalyst or a titanium catalyst. In one subclass of this class, the catalyst is a tin catalyst. In one subclass of this class, the catalyst is a titanium catalyst.

Examples of suitable titanium compounds include titanium (IV) 2-ethylhexyloxide (e.g., Tyzor® TOT available commercially from Dorf Ketal), titanium (IV) (triethanolaminato) isopropoxide (e.g., Tyzor® TE available commercially from Dorf Ketal), tetraisopropyl titanate, titanium diisopropoxide bis(acetylacetonate), and tetrabutyl titanate (e.g., Tyzor® TBT available commercially from Dorf Ketal). Examples of suitable tin compounds include butyltin tris-2-ethylhexanoate, butylstannoic acid, stannous oxalate, dibutyltin oxide.

Said unsaturated polyester has an acid number of 0-10, 0-8, 0-5, 0-3, 0-2, 0-1, 1-5, 1-4, 1-3, 2-8, 2-6, 3-8, 3-6, 4-10, 4-8, 4-6, 5-10, or 5-8 mgKOH/g.

Said unsaturated polyester has a hydroxyl number of 8-30, 10-28, 11-26, 8-25, 10-25, 12-25, 14-25, 8-23, 10-23, 12-23, 14-23, 10-20, 12-20, 14-20, 16-20, 10-18, 12-18, 14-18, 10-16, or 12-16 mgKOH/g.

Said unsaturated polyester has a number average weight of 4,000-25,000, 4,000-20,000, 4,000-15,000, 5,000-14,000, 5,000-13,000, 6,000-14,000, 6,000-13,000, 7,000-14,000, or 7,000-13,000 g/mole; weight average weight of 13,000-200,000, 14,000-100,000, 15,000-60,000, 13,000-150,000, 13,000-100,000, 13,000-80,000, 13,000-60,000, 14,000-150,000, 14,000-100,000, 14,000-80,000, 14,000-60,000, 15,000-150,000, 15,000-100,000, or 15,000-80,000 g/mole.

Said unsaturated polyester has an inherent viscosity of 0.05-0.8, 0.1-0.7, 0.2-0.7, 0.3-0.7, 0.4-0.7, 0.5-0.7, 0.6-0.7, 0.1-0.6, 0.2-0.6, 0.3-0.6, 0.4-0.6, 0.5-0.6, 0.1-0.5, 0.2-0.5, 0.3-0.5, 0.4-0.5, 0.1-0.4, 0.2-0.4, 0.3-0.4, 0.1-0.3, or 0.2-0.3 dL/g (determined at 25° C., using 0.5 weight % solution in 60/40 phenol/1,1,2,2-tetrachloroethane).

In another embodiment, the coating composition of the present invention comprises said unsaturated polyester (a) in an amount of 50-90 weight % and said resole phenolic resin crosslinker (b) in an amount of 10-50 weight %, based on the total weight of (a) and (b). In some embodiments, the unsaturated polyester (a) is in 55-85, 60-80, 65-85, 65-80, 65-75, 70-90, 70-85, 70-80, 75-85, 80-90, or 80-85 weight %; and the resole phenolic resin crosslinker (b) in 15-45, 20-40, 15-35, 20-35, 25-35, 10-30, 15-30, 20-30, 15-25, 10-20, or 15-20 weight %, based on the total weight of (a) and (b).

Said resole phenolic resin (b) contains the residues of un-substituted phenol and/or meta-substituted phenols. These particular resole resins exhibit good reactivity with said unsaturated polyester (a).

The resole phenolic resin present in the coating composition contains methylol groups on the phenolic rings. Phenolic resins having methylol functionalities are referred to as resole type phenolic resins. As is known in the art, the methylol group (—CH₂OH) may be etherated with an alcohol and present as —CH₂OR, wherein R is C1-C8 alkyl group, in order to improve resin properties such as storage stability and compatibility. For purpose of the description, the term “methylol” used herein includes both —CH₂OH and —CH₂OR and an un-substituted methylol group is CH₂OH. Said methylol groups (either —CH₂OH or —CH₂OR) are the end groups attached to the resole resins. The methylol groups are formed during the resole resin synthesis and can further react with another molecule to form ether or methylene linkages leading to macromolecules.

The phenolic resin contains the residues of un-substituted phenols or meta-substituted phenols. When starting with phenol or meta-substituted phenols to make a resole, the para and ortho positions are both available for bridging reactions to form a branched network with final methylol end groups on the resin being in the para or ortho positions relative to the phenolic hydroxyl group. To make the phenolic resole, a phenol composition is used as a starting material. The phenol composition contains un-substituted and/or meta-substituted phenols. The amount of un-substituted, meta-substituted, or a combination of the two, that is present in the phenol compositions used as a reactant to make the phenolic resole resin, is at least 50 wt. %, or at least 60 wt. %, or at least 70 wt. %, or at least 75 wt. %, or at least 80 wt. %, or at least 85 wt. %, or at least 90 wt. %, or at least 95 wt. %, or at least 98 wt. %, based on the weight of the phenol composition used as a reactant starting material.

The phenol composition is reacted with a reactive compound such as an aldehyde at an aldehyde: phenol molar ratio (using aldehyde as an example) of greater than 1:1, or at least 1.05:1, or at least 1.1:1, or at least 1.2:1, or at least 1.25:1, or at least 1.3:1, or at least 1.35:1, or at least 1.4:1, or at least 1.45:1, or at least 1.5:1, or at least 1.55:1, or at least 1.6:1, or at least 1.65:1, or at least 1.7:1, or at least 1.75:1, or at least 1.8:1, or at least 1.85:1, or at least 1.9:1, or at least 1.95:1, or at least 2:1. The upper amount of aldehyde is not limited and can be as high as 30:1, but generally is up to 5:1, or up to 4:1, or up to 3:1, or up to 2.5:1. Typically, the ratio of aldehyde: phenol is at least 1.2:1 or more, or 1.4:1 or more or 1.5:1 or more, and typically up to 3:1. Desirably, these ratios also apply to the aldehyde/unsubstituted phenol or meta-substituted phenol ratio.

The resole phenolic resin can contain an average of at least 0.3, or at least 0.4, or at least 0.45, or at least 0.5, or at least 0.6, or at least 0.8, or at least 0.9 methylol groups per one phenolic hydroxyl group, and “methylol” includes both —CH₂OH and —CH₂OR.

The phenolic resin obtained by the condensation of phenols with aldehydes of the general formula (RCHO)n, where R is hydrogen or a hydrocarbon group having 1 to 8 carbon atoms and n is 1, 2, or 3. Examples include formaldehyde, paraldehyde, acetaldehyde, glyoxal, propionaldehyde, furfuraldehyde, or benzaldehyde. Desirably, the phenolic resin is the reaction product of phenols with formaldehyde.

At least a part of the crosslinker in (b) comprises a resole type phenolic resin that is prepared by reacting either un-substituted phenol or meta-substituted phenol or a combination thereof with an aldehyde. The unsubstituted phenol is phenol (C₆H₅OH). Examples of meta-substituted phenols include m-cresol, m-ethylphenol, m-propylphenol, m-butylphenol, moctylphenol, m-alkylphenol, m-phenylphenol, m-alkoxyphenol, 3,5-xylenol, 3,5-diethyl phenol, 3,5-dibutyl phenol, 3,5-dialkylphenol, 3,5-dicyclohexyl phenol, 3,5-dimethoxy phenol, 3-alkyl-5-alkyoxy phenol, and the like.

Although other substituted phenol compounds can be used in combination with said un-substituted phenols or meta-substituted phenols for making phenolic resins, it is desirable that at least 50%, or at least 70%, or at least 80%, or at least 90%, or at least 95%, or at least 98%, or at least 100% of the phenolic compounds used to make the resole resin are unsubstituted phenol or meta-substituted phenol.

In one aspect, the resole phenolic resin used in this invention comprises residues of m-substituted phenol.

Examples of suitable commercial phenolic resins include, but are not limited to, PHENODUR® PR 516/60B (based on cresol and formaldehyde) available from Allnex, PHENODUR® PR 371/70B (based on unsubstituted phenol and formaldehyde) also available from Allnex, and CURAPHEN 40-856 B60 (based on m-cresol, p-cresol, and formaldehyde) available from Bitrez.

The phenolic resins are desirably heat curable. The phenolic resin is desirably not made by the addition of bisphenol A, F, or S (collectively “BPA”).

The resole is desirably of the type that is soluble in alcohol. The resole resin can be liquid at 25° C. The resole resin can have a weight average molecular weight from 200 to 2000, generally from 300 to 1000, or from 400 to 800, or from 500 to 600.

The coating composition of the present invention may further comprise an isocyanate crosslinker (c) in addition to said unsaturated polyester (a) and resole phenolic resin crosslinker (b).

The isocyanate crosslinker suitable for this invention may be blocked or unblocked isocyanate type. Examples of suitable isocyanate crosslinkers include, but are not limited to, 1,6-hexamethylene diisocyanate, methylene bis(4-cyclohexyl isocyanate), and isophorone diisocyanate. Desirably, the isocyanate crosslinker is isophorone diisocyanate (IPDI) or blocked IPDI available from COVESTRO as Desmodur® BL 2078/2.

In some embodiments, the crosslinker is a mixture of CURAPHEN 40-856 B60 available from Bitrez and blocked isophorone diisocyanate (IPDI).

In another embodiment, the crosslinker is a mixture of resole phenolic resin in an amount of 70-90 weight % and isocyanate in an amount of 10-30 weight %, based on the total weight of the crosslinkers.

In further embodiments, said unsaturated polyester (a) is in an amount of 70-80 weight %, said resole phenolic resin (b) in an amount of 12-27 weight %, and said isocyanate (c) in an amount of 3-8 weight %, based on the total weight of (a), (b), and (c).

In addition to resole phenolic resin and isocyanate, the coating composition of the present invention may further comprise an amino resin crosslinker. The amino resin crosslinker can be a melamine-formaldehyde type or benzoguanamine-formaldehyde type cross-linking agent, i.e., a cross-linking agent having a plurality of —N(CH₂OR³)₂ functional groups, wherein R³ is C1-C4 alkyl, preferably methyl or butyl.

In general, the amino cross-linking agent may be selected from compounds of the following formulae, wherein R³ is independently C₁-C₄ alkyl:

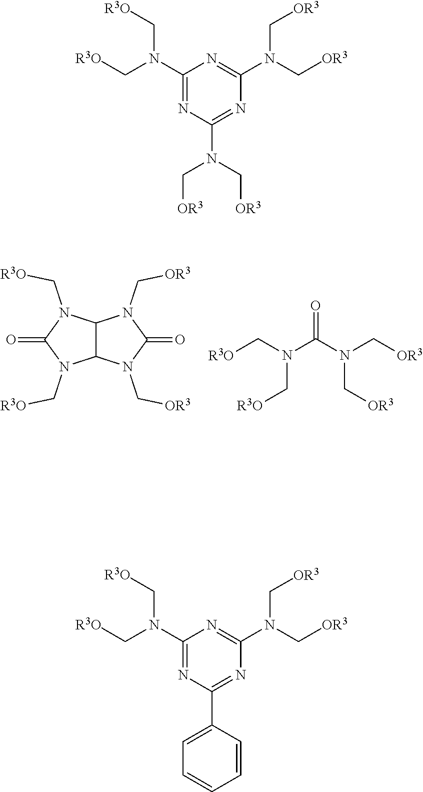

The amino containing cross-linking agents are desirably hexamethoxymethylmelamine, hexabutoxymethylmelamine, tetramethoxymethylbenzoguanamine, tetrabutoxymethylbenzoguanamine, tetramethoxymethylurea, mixed butoxy/methoxy substituted melamines, and the like. Further, amino resins having free amino (—NH₂) or imino (—NH—CH₂OR) groups may also be used for reacting with α, β-unsaturated groups on the polyesters to enhance crosslinking. Suitable commercial amino resins include Maprenal BF 987 (n-butylated benzoquanamine-formaldelhyde resin available from Ineos), Cymel 1123 (highly methylated/ethylated benzoguanamine-formaldehyde resin available from Allnex), Cymel 1158 (butylated melamine-formaldehyde resin with amino functionality available from Allnex), and other benzoquanamine-formaldelhyde and melamine-formaldehyde resins.

Desirably, in all the types of coating compositions, the crosslinker contains greater than 50 wt. %, or greater than 60 wt. %, or greater than 70 wt. %, or greater than 80 wt. %, or greater than 90 wt. % resole phenolic resin, based on the weight of the cross-linker composition. In addition to or in the alternative, the remainder of the cross-linking compounds in the cross-linking composition, if any, are isocyanate crosslinking compounds and/or amino crosslinking compounds as described above.

Any of the coating compositions of the invention can also include one or more cross-linking catalysts. Representative crosslinking catalysts include from carboxylic acids, sulfonic acids, tertiary amines, tertiary phosphines, tin compounds, or combinations of these compounds. Some specific examples of crosslinking catalysts include p-toluenesulfonic acid, phosphoric acid, the NACURE™ 155, 5076, 1051, and XC-296B catalysts sold by King Industries, BYK 450, 470, available from BYK-Chemie U.S.A., methyl tolyl sulfonimide, p-toluenesulfonic acid, dodecylbenzene sulfonic acid, dinonylnaphthalene sulfonic acid, and dinonylnaphthalene disulfonic acid, benzoic acid, triphenylphosphine, dibutyltindilaurate, and dibutyltindiacetate.

The crosslinking catalyst used in the present invention may depend on the type of crosslinker that is used in the coating composition. For example, the crosslinker can comprise an amino crosslinker and the crosslinking catalyst can comprise p-toluenesulfonic acid, phosphoric acid, unblocked and blocked dodecylbenzene sulfonic (abbreviated herein as “DDBSA”), dinonylnaphthalene sulfonic acid (abbreviated herein as “DNNSA”) and dinonylnaphthalene disulfonic acid (abbreviated herein as “DNNDSA”).

Some of these catalysts are available commercially such as, for example, NACURE™ 155, 5076, 1051, 5225, and XC-296B (available from King Industries), BYK-CATALYSTS™ (available from BYK-Chemie USA), and CYCAT™ catalysts (available from Cytec Surface Specialties). The coating compositions of the invention can comprise one or more isocyanate crosslinking catalysts such as, for example, FASCAT™ 4202 (dibutyltindilaurate), FASCAT™ 4200 (dibutyltindiacetate, both available from Arkema), DABCO™ T-12 (available from Air Products) and K-KAT™ 348, 4205, 5218, XC-6212™ non-tin catalysts (available from King Industries), and tertiary amines.

The coating composition can contain an acid or base catalyst in an amount ranging from 0.1 to 2 weight %, based on the total weight of any of the aforementioned curable polyester resins and the crosslinker composition.

In another embodiment, the coating composition of the present invention further comprises one or more organic solvents. Suitable organic solvents include xylene, ketones (for example, methyl amyl ketone), 2-butoxyethanol, ethyl-3-ethoxypropionate, toluene, butanol, cyclopentanone, cyclohexanone, ethyl acetate, butyl acetate, Aromatic 100 and Aromatic 150 (both available from ExxonMobil), and other volatile inert solvents typically used in industrial baking (i.e., thermosetting) enamels, mineral spirits, naptha, toluene, acetone, methyl ethyl ketone, methyl isoamyl ketone, isobutyl acetate, t-butyl acetate, n-propyl acetate, isopropyl acetate, methyl acetate, ethanol, n-propanol, isopropanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, 2,2,4-trimethyl-1,3-pentanediol monoisobutyrate (available commercially from Eastman Chemical Company under the trademark TEXANOL™), or combinations thereof.

The amount of solvents is desirably at least 20 wt. %, or at least 25 wt. %, or at least 30 wt. %, or at least 35 wt. %, or at least 40 wt. %, or at least 45 wt. %, or at least 50 wt. %, or at least 55 wt. % based on the weight of the solvent containing coating composition. Additionally, or in the alternative, the amount of organic solvents can be up to 85 wt. % based on the weight of the coating composition.

In some embodiments of the invention, the coating has a solvent resistance as measured by the method of ASTM D7835 of greater than 50 MEK double rubs, or greater than 60 MEK double rubs, or greater than 70 MEK double rubs or greater than 100 MEK double rubs, or 50-100, 60-100, 70-100, 80-100, 90-100, 50-150, 60-150, 70-150, 80-150, 90-150, 50-200, 60-200, 70-200, 80-200, or 90-200 MEK double rubs.

In some embodiments of the invention, the coating has a wedge bend resistance of 50-100, 55-100, 60-100, 65-100, 70-100, 75-100, 80-100, 85-100, or 90-100% pass as measured by the method of ASTM D3281.

In a further embodiment, this invention provides a coating composition for metal packaging comprising:
a. an unsaturated polyester in an amount of 70-80 weight % based on the total weight of (a), (b), and (c), which is the reaction product of the monomers comprising:
   i. 2,2,4,4-tetramethyl-1,3-cyclobutanediol in an amount of 35 to 55 mole %, based on the total moles of i-iv,
   ii. 1,4-cyclohexanedimethanol in an amount of 25 to 45 mole %, based on the total moles of i-iv,
   iii. 1,6-hexanediol or 2-methyl-1,3-propanediol or a mixture thereof in an amount of 5 to 30 mole %, based on the total moles of i-iv,
   iv. trimethylolpropane in an amount of 0 to 5 mole %, based on the total moles of i-iv,
   v. isophthalic acid in an amount of 55-85 mole %, based on the total moles of v-vii,
   vi. terephthalic acid in an amount of 5-40 mole %, based on the total moles of v-vii, and
   vii. sebacic acid or adipic acid or a mixture thereof in an amount of 0-20 mole %, based on the total moles of v-vii,
b. a resole phenolic resin in an amount of 12-27 weight % based on the total weight of (a), (b), and (c), and
c. isophorone diisocyanate in an amount of 3-8 weight % based on the total weight of (a), (b), and (c),
   wherein said unsaturated polyester has a glass transition temperature (Tg) of 40 to 100° C.; an acid number of 0 to 10 mgKOH/g; a hydroxyl number of 8 to 23 mgKOH/g; a number average molecular weight of 5,000 to 13,000 g/mole; and a weight average molecular weight of 25,000 to 130,000 g/mole; and wherein said coating has a solvent resistance of greater than 60 MEK double rubs as measured by ASTM D7835; and a wedge bend resistance (% pass) of 60-100 as measured by the method of ASTM D3281.

After formulation, the coating composition can be applied to a substrate or article. Thus, a further aspect of the present invention is a shaped or formed article that has been coated with the coating compositions of the present invention. The substrate can be any common substrate such as aluminum, tin, steel or galvanized sheeting, and the like. The coating composition can be coated onto a substrate using techniques known in the art, for example, by spraying, draw-down, roll-coating, etc., about 0.1 to about 4 mils (1 mil=25 μm), or 0.5 to 3, or 0.5 to 2, or 0.5 to 1 mils of wet coating onto a substrate. The coating can be cured at a temperature of about 50° C. to about 230° C., for a time period that ranges from about 5 seconds to about 90 minutes and allowed to cool. Examples of coated articles include metal cans for food and beverages, in which the interiors are coated with the coating composition of the present invention.

Thus, this invention further provides an article, of which at least a portion is coated with the coating composition of the present invention.

### EXAMPLES

This invention can be further illustrated by the following examples thereof, although it will be understood that these examples are included merely for purposes of illustration and are not intended to limit the scope of the invention unless otherwise specifically indicated.

### Coating Test Methods:

### Substrate, Coated Test Panel Preparation, Film Weight

Substrate from ThyssenKrupp Rasselstein GmbH was used: electro tin plated (ETP), thickness 0.18 mm with standard chromium passivation 311, temper TH 550, tinning 2.8/2.8 g/m² and DOS oiling 4+/−2 mg/m². The panels were coated by casting wet films with wire wound rods yielding a dry film weight of 6 to 7 grams/m². The cast panels were placed in a rack vertically. A drying oven, LUT 6050 from Thermo scientific was preheated at 205° C. The coated panels in the rack were then placed into the oven for 22 minutes of bake cycle time in order to allow the coatings to be baked at 195° C. Peak Metal Temperature (PMT) for 10 minutes. At the conclusion of the baking cycle, the panel rack was removed from the oven and allowed to cool to ambient temperature. A Sencon SI9600 coating thickness gauge was used to confirm the dry film weight of the applied coatings.

### Wedge Bend

A coupon measuring 1.5″ wide×4″ long was cut from a coated panel. This coupon was tested by a Gardco coverall bend and impact tester following ASTM D 3281. To make a bend test, the coated coupon was first bent over a ⅛″ (0.32 cm) steel rod. The bent coupon was placed between the parts of a butt hinge. The hinge made of two steel blocks is attached to the base below the guide tube. When the hinge is closed, it creates a wedge shape gap between the upper and lower parts ranging from ⅛″ at the hinged end to zero thickness at the free end. Then the impact tool, flat face down, was dropped from a height of one or two feet onto the upper part of the hinge. Once a coated coupon was bent and impacted into a wedge shape, it was then soaked in a copper sulfate solution, acidified with hydrochloric acid in distilled water, for 5 minutes to make any cracks in the coating visible. Excess copper sulfate solution was removed by washing with water and blotting with a dry towel. Wedge bend failure (mm), measured by using a ruler and a lighted magnifying glass, is defined as the total length of a continuous crack along the bent edge of the coupon. The result is reported as Pass % of wedge bend which is calculated by:

$$Pass \% of wedge bend = \frac{( Total length - wedge bend failure )}{Total length} \times 100 \%$$

Each Pass % of wedge bend in this experiment is an average value from 3 repeated tests.

### Methyl Ethyl Ketone (MEK) Double Rubs

The resistance to MEK solvent was measured using a MEK rub test machine (Gardco MEK Rub Test Machine AB-410103EN with 1 kg block). This test was carried out similar to ASTM D7835. MEK solvent resistance was reported as the number of double rubs a coated panel can withstand before the coating starts to be removed. For example, one back-and-forth motion constitutes one double rub.

### Sterilization Resistance Testing

An 73 mm sanitary ends was stamped with a C-frame eccentric press, T20 Fv from MIOS out of coated panel. The sanitary ends were then placed in a 16 oz wide mouth Le Parfait glass jar filled with the food simulant Two different food simulants were evaluated:
Lactic acid: 2% lactic acid, 98% deionized water.
Acetic Acid: 3% acetic acid, 97% deionized water.
Sodium chloride: 5% NaCl 95% deionized water

The jars with properly closed top were placed in an autoclave, CYTEC Model DX 45, for 1 hr at 131° C. Once the retort process was finished, the autoclave was allowed to depressurize to ambient conditions. After the completion of sterilization cycle, the glass jars containing the test coupons were then removed from the autoclave. The sanitary ends were removed from the jars and washed under water and blotted dry with paper towels. The retort performance is rated on a scale of 0 (worst) to 5 (best) using a visual observation. For each food simulant, the retort performance was rated on (1) blush (2) roughness (3) cross-hatch adhesion (following ASTM D 3359). An overall retort performance is reported as Total Retort % calculated by:

$$Total Retort \% = \frac{average of rating ( 1 ) to ( 3 ) from 2 \% lactic acid + average of rating ( 1 ) to ( 5 ) from 3 \% acetic acid + average of rating from 5 \% Sodium chloride}{5}$$

$$Total \% acid resistance after sterilization = \frac{average of rating ( 1 ) to ( 3 ) from 2 \% lactic acid + average of rating ( 1 ) to ( 3 ) from 3 \% acetic acid}{5}$$

### Example 1: Synthesis of Unsaturated Polyester (Resin 1)

The unsaturated polyester (Resin 1) was produced using a resin kettle reactor setup controlled with automated control software. The resin was produced on a 3.5-4.5 mole scale using a 2 L kettle with overhead stirring and a partial condenser topped with total condenser and Dean Stark trap. Approximately 10 wt % (based on reaction yield) azeotroping solvent of high boiling point Aromatic 150ND (A150ND, available from ExxonMobile) was used to both encourage egress of the water condensate out of the reaction mixture and keep the reaction mixture viscosity at a reasonable level using the standard paddle stirrer. Isophthalic acid (IPA), terephthalic acid (TPA), 1,4-cyclohexane dimethanol (CHDM), 2,2,4,4-tetramethyl-cyclobutanediol (TMCD), 1,6-hexanediol (HDO), trimethylolpropane (TMP), and 0-10 wt % A150ND were added to the reactor, which was then completely assembled. Fascat 4100 (monobutyltin oxide, available from PMC Organometallix Inc.) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was sufficiently fluid, the stirring was started to encourage even heating of the mixture. At 150° C., the control of heating was switched to automated control and the temperature was ramped to 200° C. over the course of 3 h. The reaction was held at 200° C. for 1 h and then heated to 240° C. at a rate of 0.3 degrees/m. The reaction was then held at 240° C. and sampled every 1-2 h upon clearing until the desired acid value for Stage 1 was reached. An overnight hold temperature of 150° C. was utilized, and any additional A150ND necessary to reach the desired ˜10 wt % was added at 150° C. prior to reheating to the reaction temperature. Upon reaching the Stage 1 target acid value, the reaction mixture was cooled to 190° C., and 4-methoxyphenol (MeHQ, 1% by weight based on MA) was added and allowed to stir for 15 m. Next, in Stage 2 maleic anhydride (MA) was added to the reaction mixture and heated to 220-230° C. at 1.5° C./m. The acid value was monitored every 30-60 m until the final desired acid value was reached. The reaction mixture was then further diluted with Aromatic 100 (A100, available from ExxonMobile) to target a weight percent solids of 55-60%. This solution was filtered through a ˜250 μm paint filter prior to use in the formulation and application testing. It should be noted that the glycol excesses were determined empirically for the lab reactor and may be different depending on the partial condenser and reactor design used. The glycol: acid ratio was also manipulated to enable achieving the desired molecular weight, OHN, and AN. The raw materials are shown in Table 1.

TABLE 1
Charge

| | | | | | |
|---|---|---|---|---|---|
| | | | | Charge | |
| | | | | Weight | |
| | | | | (including | |
| Raw Material | Moles | Equivalents | Weight | excess) | % Excess |

Stage 1

| | | | | | |
|---|---|---|---|---|---|
| PIA | 2.8125 | 5.6250 | 467.24 | 467.24 | 0 |
| PTA | 1.0125 | 2.0250 | 168.21 | 168.21 | 0 |
| TMCD | 1.9584 | 3.9168 | 282.42 | 296.54 | 5 |
| 1,4-CHDM | 1.6320 | 3.2640 | 235.35 | 237.70 | 1 |
| HDO | 0.9326 | 1.8651 | 110.21 | 111.31 | 1 |
| TMP | 0.1399 | 0.4197 | 18.77 | 18.96 | 0 |

Stage 2

| MA | 0.6750 | 1.3500 | 66.19 | 66.19 | 0 |
|---|---|---|---|---|---|
| | | $\begin{matrix}Total Charge & 1282.2 \\ Minus Condensate & 161.04 \\ Yield & 1121.16\end{matrix}$ | | | |
| (Catalyst) | Concentration | | | | |
| Fascat 4100 | 400 | | | 0.96 | |
| (Processes Solvent) | Wt. % | | | | |
| A150ND | 10 | | | 151.90 | |
| (Radical Inhibitor) | wt % on MA | | | | |
| MeHQ | 1 | | | 0.66 | |
| (Processes Solvent) | Final Wt. % | | | | |
| A100 | 60 | | | 652.15 | |

### Examples 2-12: Synthesis of Unsaturated Polyesters (Resins 2-12)

Resins 2-12 were also synthesized using the same method as above. Table 2 lists the compositions of Resins 1-12, and Table 3 lists their resin properties.

Glass transition temperature (Tg) was determined using a Q2000 differential scanning calorimeter (DSC) from TA Instruments, New Castle, DE, US, at a scan rate of 20° C./min. Number average molecular weight (Mn) and weight average molecular weight (Mw) were measured by gel permeation chromatography (GPC) using polystyrene equivalent molecular weight and THF solvent. Acid number was measured by using a procedure based on ASTM D7253-1 entitled “Standard Test Method for Polyurethane Raw Materials: Determination of Acidity as Acid Number for Polyether Polyols,” and hydroxyl number was measured using a procedure based on ASTM E222-1 entitled “Standard Test Methods for Hydroxyl Groups Using Acetic Anhydride. Table 3 lists the resin properties of Resins 1-12.

TABLE 2
Synthesized Unsaturated Polyesters

| | Mole Ratio Based on Total Acids (%) | | | | | | | | |
|---|---|---|---|---|---|---|---|---|---|
| Resin | SE | AD | MA | IPA | TPA | TMP | TMCD | CHDM | HDO |
| # | mol % | mol % | mol % | mol % | mol % | mol % | mol % | mol % | mol % |
| 1 | 0 | 0 | 15 | 62.5 | 22.5 | 3 | 42 | 35 | 20 |
| 2 | 15 | 0 | 15 | 55 | 15 | 0 | 45 | 35 | 20 |
| 3 | 0 | 0 | 15 | 62.5 | 22.5 | 0 | 45 | 35 | 20 |
| 4 | 15 | 0 | 15 | 55 | 15 | 3 | 42 | 35 | 20 |
| 5 | 7.5 | 0 | 7.5 | 62.5 | 22.5 | 1.5 | 43.5 | 35 | 20 |
| 6 | 5 | 0 | 9.8 | 62.6 | 22.6 | 3 | 42 | 35 | 20 |
| 7 | 0.8 | 0 | 11.7 | 63.7 | 23.8 | 2 | 43 | 35 | 20 |
| 8 | 5.5 | 0 | 15 | 59.8 | 19.8 | 0 | 45 | 35 | 20 |
| 9 | 11.4 | 0 | 15 | 56.8 | 16.8 | 2 | 43 | 35 | 20 |
| 10 | 0 | 0 | 15 | 62.5 | 22.5 | 3 | 42 | 35 | 20 |
| 11 | 15 | 0 | 5.7 | 59.6 | 19.6 | 3 | 42 | 35 | 20 |
| 12 | 0 | 7.5 | 7.5 | 62.5 | 22.5 | 1.5 | 43.5 | 35 | 20 |

TABLE 3
Resin Properties of Unsaturated Polyesters

| Resin # | Tg, C | Mn | Mw | AN | OHN |
|---|---|---|---|---|---|
| 1 | 71 | 5891 | 50964 | 2.8 | 22.3 |
| 2 | 48 | 8371 | 41963 | 3.0 | 13.0 |
| 3 | 70 | 7161 | 25602 | 4.4 | 14.7 |
| 4 | 38 | 4523 | 16937 | 6.6 | 31.2 |
| 5 | 60 | 6246 | 21735 | 4.1 | 18.7 |
| 6 | 67 | 7922 | 86490 | 4.7 | 13.5 |
| 7 | 76 | 8694 | 8694 | 3.0 | 13.9 |
| 8 | 59 | 9925 | 25414 | 4.4 | 20.6 |
| 9 | 49 | 5885 | 41385 | 2.6 | 24.5 |
| 10 | 62 | 5752 | 31417 | 5.8 | 21.7 |
| 11 | 49 | 7872 | 73861 | 3.0 | 15.6 |
| 12 | 63 | 6773 | 24998 | 4.0 | 22.4 |

### Comparative Examples 1-2: Synthesis of Comparative Unsaturated Polyesters

Using the same method as above, comparative resins 1-2 (CR1 and CR2) were also synthesized. Table 4 lists the compositions of resins CR1-2. Table 5 lists their resin properties. CR1 has low maleic anhydride (2.3 mole %), high hydroxyl number (26.6 mgKOH/g), and low Mw (15,402 g/mole) as compared to the inventive polyester. CR2 also has low maleic anhydride (2.3 mole %), high hydroxyl number (27.3), and low Mw (14,417).

TABLE 4
Synthesized Comparative Unsaturated Polyesters

| | Mole Ratio Based on | | | | Mole Ratio Based on | | | |
|---|---|---|---|---|---|---|---|---|
| | Total Acids (%) | | | | Total Alcohols (%) | | | |
| Resin | SE | MA | IPA | TPA | TMP | TMCD | CHDM | HDO |
| # | mol % | mol % | mol % | mol % | mol % | mol % | mol % | mol % |
| CR1 | 14.8 | 2.3 | 61.5 | 21.5 | 1 | 44 | 35 | 20 |
| CR2 | 14.8 | 2.3 | 61.5 | 21.5 | 1 | 44 | 35 | 20 |

TABLE 5
Resin Properties of Comparative Unsaturated Polyesters

| Run | Tg, C | Mn | Mw | AN | OHN |
|---|---|---|---|---|---|
| 13 | 49 | 5322 | 15402 | 3.2 | 26.6 |
| 30 | 45 | 4852 | 14417 | 3.7 | 27.3 |
| 22 | 78 | 7973 | 185948 | 3.7 | 15.7 |

### Comparative Examples 3-7: Synthesis of Polyesters without Ethylenically Unsaturated Groups (CR3-6)

The polyesters were produced using a resin kettle reactor setup controlled with automated control software. The compositions were produced on a 3.5-4.5 mole scale using a 2 L kettle with overhead stirring and a partial condenser topped with total condenser and Dean Stark trap. Approximately 10 wt % (based on reaction yield) azeotroping solvent of high boiling point Aromatic 150ND (A150ND, available from ExxonMobile) was used to both encourage egress of the water condensate out of the reaction mixture and keep the reaction mixture viscosity at a reasonable level using the standard paddle stirrer. Isophthalic acid (IPA), terephthalic acid (TPA), sebacic acid (SE), succinic acid (SU), 1,4-cyclohexane dimethanol (CHDM), 2,2,4,4-tetramethyl-cyclobutanediol (TMCD), 1,6-hexanediol (HDO), trimethylolpropane (TMP), and 0-10 wt % A150ND were added to the reactor, which was then completely assembled. Fascat 4100 (monobutyltin oxide, available from PMC Organometallix Inc.) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was sufficiently fluid, the stirring was started to encourage even heating of the mixture. At 150° C., the control of heating was switched to automated control and the temperature was ramped to 200° C. over the course of 3 h. The reaction was held at 200° C. for 1 h and then heated to 240° C. at a rate of 0.3 degrees/m. The reaction was then held at 240° C. and sampled approximately every 60 m upon clearing until the desired acid value was reached. An overnight hold temperature of 150° C. was utilized, and any additional A150ND was added at 150° C. prior to reheating to the reaction temperature. The reaction mixture was then further diluted with Aromatic 100 (A100, available from ExxonMobile) to target a weight percent solid of 55-60%. This solution was filtered through a ˜250 μm paint filter prior to use in the formulation and application testing. As with previous examples, the glycol excesses were determined empirically for the lab reactor and may be different depending on the partial condenser and reactor design used. An example of a basic charge sheet is provided in Table 6. The glycol: acid ratio was also manipulated to enable achieving the desired molecular weight, OHN, and AN. The same analytical methods were used as described above.

TABLE 6
Charge

| | | | | | |
|---|---|---|---|---|---|
| | | | | Charge | |
| | | | | Weight | |
| | | | | (including | |
| Raw Material | Moles | Equivalents | Weight | excess) | % Excess |

Stage 1

| PIA | 2.2500 | 4.5000 | 373.79 | 373.79 | 0 |
|---|---|---|---|---|---|
| PTA | 0.8100 | 1.6200 | 134.57 | 134.57 | 0 |
| Sebacic Acid | 0.2700 | 0.5400 | 54.62 | 54.62 | 0 |
| Succinic Acid | 0.2700 | 0.5400 | 31.89 | 31.89 | 0 |
| TMCD | 1.6071 | 3.2142 | 231.76 | 243.35 | 5 |
| 1,4-CHDM | 1.2931 | 2.5862 | 186.48 | 188.34 | 1 |
| HDO | 0.7389 | 1.4778 | 87.32 | 88.20 | 0 |
| TMP | 0.0554 | 0.1663 | 7.44 | 7.51 | 1 |
| MA | 0.6750 | 1.3500 | 66.19 | 66.19 | 0 |
| | | $\begin{matrix}Total Charge & 1100.43 \\ Minus Condensate & 128.33 \\ Yield & 972.1\end{matrix}$ | | | |
| (Catalyst) | Concentration | | | 0.79 | |
| Fascat 4100 | 400 | | | | |
| (Processes Solvent) | Wt. % | | | | |
| A150ND | 10 | | | 124.78 | |
| (Processes Solvent) | Final Wt. % | | | | |
| A100 | 60 | | | 538.37 | |

Table 7 lists the compositions of resins CR4-7. Table 8 lists their resin properties. These examples represent negative controls without the presence of maleic anhydride. CR4 and CR5 represent resins in which the maleic anhydride was replaced with succinic acid, which has the same number of carbon groups but is saturated

TABLE 7
Synthesized Comparative Polyesters without Unsaturated Groups

| | Mole Ratio Based on | | | | Mole Ratio Based on | | | |
|---|---|---|---|---|---|---|---|---|
| | Total Acids (%) | | | | Total Alcohols (%) | | | |
| Resin | SE | SU | IPA | TPA | TMP | TMCD | CHDM | HDO |
| # | mol % | mol % | mol % | mol % | mol % | mol % | mol % | mol % |
| CR3 | 7.5 | 7.5 | 62.5 | 22.5 | 1.5 | 43.5 | 35 | 20 |
| CR4 | 15 | 15 | 55 | 15 | 0 | 45 | 35 | 20 |
| CR5 | 8.5 | 0 | 65.7 | 25.7 | 0.7 | 44.3 | 35 | 20 |
| CR6 | 0 | 0 | 70 | 30 | 1.5 | 43.5 | 35 | 20 |

TABLE 8
Resin Properties of Comparative Polyesters
without Unsaturated Group

| Resin # (Run) | Tg, C | Mn | Mw | AN | OHN |
|---|---|---|---|---|---|
| CR3 | 52 | 6962 | 22276 | 4.0 | 17.8 |
| CR4 | 40 | 7456 | 20012 | 3.3 | 13.2 |
| CR5 | 50 | 7229 | 23001 | 3.8 | 23.1 |
| CR6 | 53 | 5998 | 20207 | 6.1 | 28.0 |

### Example 13: Preparation of Coating Formulations (F1-12 and CF1-6)

Coating formulations were prepared in accordance with the composition listed in Table 9 by using Resins 1-12 and Comparative Resins CR 1-6 respectively. Coating formulations (F1-12) prepared from Resins 1-12 are listed in Table 10, and the comparative formulations (CF 1-7) prepared from CR 1-6 are listed in Table 9.

Prior to formulating, all polyester resins were diluted in aromatic 100 to 55 wt. % solids. An empty jar with a lid was labeled and pre-weighted to record the tare weight. For each formulation, Curaphen 40-853-B50, Desmodur® BL 2078/2, Nacure® XC-296B, Lubaprint 897 PM (ND), Byk 392 and aromatic 100 solvent were weighed out respectively and added to the resin solution in order. The formulation was then sheared for 2 min at 3000 RPMs with a SpeedMixer DAC 150.1 FVZ-K

A food grade approved Desmodur® BL 2078/2 available from Covestro AG, and Curaphen 40-853-B60 available from Bitrez were chosen as blocked IPDI trimer and m-cresol phenolic-formaldehyde resin crosslinkers, respectively. A food grade approved Nacure® XC-296B available from King Industrials was chosen as H3PO4 catalyst. A carnauba wax, Lubaprint 897 PM (ND) available from Münzing was used and a surface additive, Byk 392, available from BYK was chosen.

TABLE 9
Coating Formulations (F1-12 and CF1-7)

| | Solids/ | Weight |
|---|---|---|
| Component | Active % | (g) |
| Polyester resin | 55% | 34.86 |
| Curaphen 40-853-B50 | 50% | 10.23 |
| Desmodur ® BL 2078/2 | 50% | 2.14 |
| Nacure ® XC-296B | 60% | 0.13 |
| Lubaprint 897 PM (ND) | 60% | 1.69 |
| Byk 392 | 28% | 0.28 |
| Aromatic 100 | 0% | 10.68 |

| | |
|---|---|
| Total | 60.00 |
| % Total solids | 43.4% |
| % Polyester resin on total binder | 75.00% |
| % IPDI on total binder | 5.00% |
| % Phenolic on total binder | 20.00% |

### Example 14: Coating Properties of Formulations (F1-12)

The formulations prepared were applied on substrate from ThyssenKrupp Rasselstein GmbH, electro tin plated (ETP), thickness 0.18 mm with standard chromium passivation 311, temper TH 550, tinning 2,8/2,8 g/m² and DOS oiling 4+/−2 mg/m². by casting wet films with wire wound rods yielding to dry film weight to achieve approximately 6-8 grams/m². The cast panels were placed in a rack and held vertically in an oven for cure

A drying oven, LUT 6050 from Thermo scientific was preheated at 205° C. The coated panels in the rack were then placed into the oven for 22 minutes of bake cycle time in order to allow the coatings to be baked at 195° C. Peak Metal Temperature (PMT) for 10 minutes. At the conclusion of the baking cycle, the panel rack was removed from the oven and allowed to cool to ambient temperature. A Sencon SI9600 coating thickness gauge was used to confirm the dry film weight of the applied coatings.

The coatings thus prepared were then tested for their properties according to the methods described previously. Table 10 lists the coating properties of Formulations F1-12. Table 11 lists the coating properties of Comparative Formulations CF1-6.

TABLE 10
Coating Properties

| | | MEK | Pass % | | |
|---|---|---|---|---|---|
| | Resin | Double | of Wedge | % total | % acid |
| | # | rubs | bend | retort | resistance |
| F1 | 1 | 200 | 74% | 73% | 60% |
| F2 | 2 | 200 | 82% | 69% | 53% |
| F3 | 3 | 135 | 73% | 80% | 70% |
| F4 | 4 | 200 | 81% | 73% | 60% |
| F5 | 5 | 63 | 62% | 73% | 60% |
| F6 | 6 | 200 | 75% | 80% | 70% |
| F7 | 7 | 200 | 82% | 87% | 80% |
| F8 | 8 | 170 | 54% | 76% | 63% |
| F9 | 9 | 200 | 68% | 69% | 53% |
| F10 | 10 | 200 | 72% | 76% | 63% |
| F11 | 11 | 200 | 79% | 82% | 73% |

### Comparative Example 8: Coating Properties of Comparative Formulations (CF1-6)

TABLE 11
Comparative Coating Properties

| | | MEK | Pass % | | |
|---|---|---|---|---|---|
| | Resin | Double | of Wedge | % total | % acid |
| Formulation | # | rubs | bend | retort | resistance |
| CF1 | CR1 | 11 | 5% | 78% | 67% |
| CF2 | CR2 | 11 | 11% | 76% | 63% |
| CF3 | CR3 | 13 | 46% | 71% | 57% |
| CF4 | CR4 | 4 | 65% | 71% | 57% |
| CF5 | CR5 | 5 | 5% | 78% | 67% |
| CF6 | CR6 | 9 | 0% | 84% | 77% |

### Examples 15-17: Synthesis of Unsaturated Polyesters using Tin-free catalyst (Resins TF1-3)

Using the same method as above, resins TF1-3 were synthesized by replacing the catalyst Fascat 4100 (monobutyltin oxide) with titanium isopropoxide (concentration: 90 ppm). Table 12 lists the compositions of Resins TF1-3, and Table 13 lists their resin properties.

TABLE 12
Synthesized Unsaturated Polyesters Using Titanium Catalyst

| | Mole Ratio Based on | | | | | Mole Ratio Based on | | | |
|---|---|---|---|---|---|---|---|---|---|
| | Total Acids (%) | | | | | Total Alcohols (%) | | | |
| Resin | SE | AD | MA | IPA | TPA | TMP | TMCD | CHDM | HDO |
| # | mol % | mol % | mol % | mol % | mol % | mol % | mol % | mol % | mol % |
| TF1 | 7.5 | 0 | 7.5 | 62.5 | 22.5 | 1.5 | 43.5 | 35 | 20 |
| TF2 | 0 | 7.5 | 7.5 | 62.5 | 22.5 | 1.5 | 43.5 | 35 | 20 |
| TF3 | 0 | 0 | 7.5 | 66.25 | 26.25 | 1.5 | 40 | 28.5 | 30 |

TABLE 13
Resin Properties of Unsaturated Polyesters with Titanium Catalyst

| Resin # | Tg, C | Mn | Mw | AN | OHN |
|---|---|---|---|---|---|
| TF1 | 54 | 6475 | 21671 | 4.8 | 15.6 |
| TF2 | 62 | 6609 | 23169 | 4.6 | 19.3 |
| TF3 | 57 | 4626 | 13256 | 3.7 | 28.5 |

The invention has been described in detail with reference to the embodiments disclosed herein, but it will be understood that variations and modifications can be effected within the spirit and scope of the invention.

1. A coating composition for metal packaging, comprising:
a. an unsaturated polyester, which is the reaction product of the monomers comprising:
i. 2,2,4,4-tetramethyl-1,3-cyclobutanediol (TMCD) in an amount of 30 to 60 mole %, based on the total moles of i-iii,
ii. a diol other than TMCD in an amount of 40 to 70 mole %, based on the total moles of i-iii,
iii. a triol in an amount of 0 to 8 mole %, based on the total moles of i-iii,
iv. an α,β-unsaturated diacid or anhydride in an amount of 3 to 20 mole %, based on the total moles of iv-vi,
v. an aromatic diacid in an amount of 55 to 97 mole %, based on the total moles of iv-vi, and
vi. an aliphatic diacid in an amount of 0 to 25 mole %, based on the total moles of iv-vi, and
b. a resole phenolic resin crosslinker having at least one methylol group,
wherein said unsaturated polyester has a glass transition temperature (Tg) of 40 to 110° C., acid number of 0 to 10 mgKOH/g, hydroxyl number of 8 to 30 mgKOH/g, number average molecular weight of 5,000 to 15,000 g/mole, and weight average molecular weight of 20,000 to 150,000 g/mole; and
wherein said coating has a solvent resistance of greater than 50 MEK double rubs as measured by ASTM D7835 and a wedge bend resistance (% pass) of 50-100 as measured by ASTM D3281.

2. The coating composition of claim 1, wherein 2,2,4,4-tetramethyl-1,3-cyclobutanediol (TMCD) (i) is in an amount of 35-55 mole %, said diol other than TMCD (ii) in an amount of 40 to 65 mole %, saud triol (iii) in an amount of 0 to 5 mole %, said α,β-unsaturated diacid or anhydride (iv) in an amount of 5 to 18 mole, said aromatic diacid (v) in an amount of 62 to 95 mole %, and said aliphatic diacid (vi) in an amount of 0 to 20 mole %.

3. The coating composition of claim 1, wherein said diol other than TMCD (ii) is selected from the group comprising 1,4-cyclohexanedimethanol, 1,3-cyclohexane-dimethanol, 1,6-hexanediol, 1,4-butanediol, 2-methyl-1,3-propanediol, neopentyl glycol, and a mixture thereof.

4. The coating composition of claim 1, wherein said α,β-unsaturated diacid or anhydride (iv) is one or more selected from the group comprising maleic anhydride, maleic acid, fumaric acid, itaconic anhydride, and itaconic acid,

5. The coating composition of claim 1, wherein said aliphatic diacid (vi) is one or more selected from succinic acid, adipic acid, sebacic acid, 1,4-cyclohexane dicarboxylic acid, and 1,3-cyclohexane dicarboxylic acid.

6. The coating composition of claim 1, wherein said unsaturated polyester (a) has a hydroxyl number of 10-20 mgKOH/g.

7. The coating composition of claim 1, wherein said unsaturated polyester (a) has a Tg of 40-80° C.

8. The coating composition of claim 1, wherein said unsaturated polyester (a) is made by using a titanium catalyst.

9. The coating composition of claim 1, wherein the unsaturated polyester (a) is in an amount of 50 to 90 weight % and resole phenolic resin (b) in an amount of 10 to 50 weight %, based on the total weight of (a) and (b).

10. The coating composition of claim 1, further comprising an isocyanate crosslinker (c) in addition to said unsaturated polyester (a) and said resole phenolic resin crosslinker (b).

11. The coating composition of claim 1, wherein said resole phenolic resin is in an amount of 70-90 weight % and said isocyanate in an amount of 10-30 weight %, based on the total weight of the crosslinkers.

12. The coating composition of claim 1, wherein said resole phenolic resin comprises residues of m-substituted phenol.

13. The coating composition of claim 1, wherein said resole phenolic resin is CURAPHEN 40-856 B60 available from Bitrez.

14. The coating composition of claim 1, wherein said isocyanate is isophorone diisocyanate.

15. The coating composition of claim 1, wherein said resole phenolic resin is CURAPHEN 40-856 B60 and said isocyanate is a blocked isophorone diisocyanate.

16. The coating composition of claim 1, wherein said unsaturated polyester (a) in an amount of 70-80 weight %, said resole phenolic resin (b) in an amount of 12-27 weight %, and said isocyanate (c) in an amount of 3-8 weight %, based on the total weight of (a), (b), and (c).

17. The coating composition of claim 1, further comprising one or more organic solvents selected from the group comprising xylene, methyl amyl ketone, 2-butoxyethanol, ethyl-3-ethoxypropionate, toluene, butanol, cyclopentanone, cyclohexanone, ethyl acetate, butyl acetate, Aromatic 100, and Aromatic 150 available from ExxonMobil.

18. The coating composition of claim 1, wherein said coating has a solvent resistance of greater than 70 MEK double rubs as measured by ASTM D7835, and a wedge bend resistance (% pass) of 70-100 as measured by ASTM D3281.

19. A coating composition for use in metal packaging, comprising:
a. an unsaturated polyester in an amount of 70-80 weight % based on the total weight of (a), (b), and (c), which is the reaction product of the monomers comprising:
i. 2,2,4,4-tetramethyl-1,3-cyclobutanediol in an amount of 35 to 55 mole %, based on the total moles of i-iv,
ii. 1,4-cyclohexanedimethanol in an amount of 25 to 45 mole %, based on the total moles of i-iv,
iii. 1,6-hexanediol or 2-methyl-1,3-propanediol or a mixture thereof in an amount of 5 to 30 mole %, based on the total moles of i-iv,
iv. trimethylolpropane in an amount of 0 to 5 mole %, based on the total moles of i-iv,
v. isophthalic acid in an amount of 55-85 mole %, based on the total moles of v-vii,
vi. terephthalic acid in an amount of 5-40 mole %, based on the total moles of v-vii, and
vii. sebacic acid or adipic acid or a mixture thereof in an amount of 0-20 mole %, based on the total moles of v-vii,
b. a resole phenolic resin in an amount of 12-27 weight % based on the total weight of (a), (b), and (c), and
c. isophorone diisocyanate in an amount of 3-8 weight % based on the total weight of (a), (b), and (c),
wherein said unsaturated polyester has a glass transition temperature (Tg) of 40 to 100° C.; an acid number of 0 to 10 mgKOH/g; a hydroxyl number of 8 to 23 mgKOH/g; a number average molecular weight of 5,000 to 13,000 g/mole; and a weight average molecular weight of 25,000 to 130,000 g/mole; and
wherein said coating has a solvent resistance of greater than 60 MEK double rubs as measured by ASTM D7835; and a wedge bend resistance (% pass) of 60-100 as measured by the method of ASTM D3281.

20. An article, of which at least a portion is coated with the coating composition of claim 1.
